(19) United States
(12) Patent Application Publication
(10) Pub. No.: US 2026/0086508 A1
(43) Pub. Date: Mar. 26, 2026

(54) SAFETY DEVICE AND PROCEDURE

(71) Applicant: PIZZATO ELETTRICA S.R.L., MAROSTICA - VI (IT)

(72) Inventors: Marco Pizzato, Marostica (VI) (IT); Giuseppe Pizzato, Marostica (VI) (IT)

(21) Appl. No.: 19/336,484

(22) Filed: Sep. 22, 2025

(30) Foreign Application Priority Data
Sep. 25, 2024 (IT) 102024000021312

(51) Int. Cl. G05B 9/02; G05B 13/02

(52) U.S. Cl. CPC G05B 9/02; G05B 13/0265

(57) ABSTRACT

A safety device is configured to detect a hazardous situation in an industrial machine or plant. The safety device includes: at least one sensor for detecting parameters associated with the hazardous situation, a transmitter for safely transmitting a safety signal, and a processor having a deterministic portion for processing at least a first part of the parameters in accordance with a deterministic model and a probabilistic portion for processing at least a second part of the parameters in accordance with a probabilistic model.

### CROSS-REFERENCE TO RELATED APPLICATION(S)

This patent application claims priority from Italian patent application no. 102024000021312 filed on Sep. 25, 2024, the entire disclosure of which is incorporated herein by reference.

### TECHNICAL FIELD

The present disclosure relates, for example but without limitation to generality, to a safety device for industrial machines or plants and a related safety process.

### BACKGROUND

As is known, an industrial machine or installation, hereafter referred to as a machine, that presents a hazardous condition during its operation is generally equipped with safety devices that inhibit the operation of the machine should a dangerous situation occur for an operator.

For example, such a hazardous condition occurs when machine parts are in motion, under pressure and/or at high temperature and within easy reach of an operator.

Examples of safety devices are scanners, radars, TOF (Time Of Flight) or 3D cameras that monitor an area around the machine to inhibit its operation if they detect an operator or an unauthorized object in the vicinity of the machine.

Generally, such safety devices comprise radar, TOF or optical sensors, and the signal to inhibit or allow machine operation is transmitted on the basis of the deterministic comparison of the values detected by these sensors, possibly reprocessed, with predetermined thresholds.

However, situations may arise where the data collected or the predetermined thresholds set are not sufficient to detect a potentially dangerous situation for an operator.

In fact, the deterministic comparison of the measured values with the predetermined thresholds does not allow for more analysis, e.g. probabilistic analysis, of the data collected by the sensors with the risk of not detecting a potentially dangerous situation.

However, this deterministic threshold operation is actually imposed by national and international regulations on the functional safety of industrial machinery that govern its design. In fact, it is well known that every safety device must declare a minimum level of reliability also calculated on the basis of the probability of error and failure of the device. It is clear that calculating the probability of error or failure of a device that deterministically analyses data collected from sensors is advantageous and much simpler than calculating the probability of error or failure of a device that probabilistically analyses data collected from sensors.

An aim of the present disclosure is therefore to provide a safety device that enables the analysis capacity of data collected by sensors to be increased without reducing the reliability level of the safety device.

Another purpose of the present disclosure is to realize a safety device and to develop a safety procedure to increase safety for an operator.

### SUMMARY

A safety device in accordance with an aspect of the present disclosure is configured to detect a hazardous situation in an industrial machine or plant and to activate a safety function of the industrial machine or plant in response to detecting the hazardous situation. The safety device includes: sensor means for detecting parameters associated with the hazardous situation, transmission means for safely transmitting a safety signal, and a processing unit having a deterministic portion for processing at least a first part of the parameters in accordance with a deterministic model and a probabilistic portion for processing at least a second part of the parameters in accordance with a probabilistic model.

A safety procedure in accordance with another aspect of the present disclosure is designed to detect a hazardous situation in an industrial machine or plant and to activate a safety function of that machine if that hazardous situation is detected. The safety procedure includes detecting one or more parameters of that machine associated with that hazardous situation, and processing these parameters in order to detect this hazardous situation. At least a first part of the parameters is processed according to a deterministic model and at least a second part of the parameters is processed according to a probabilistic model.

### BRIEF DESCRIPTION OF THE DRAWINGS

In the following, certain forms of implementation of the present disclosure will be described for a better understanding of the present disclosure by way of non-limiting example and with reference to the attached figures, in which:

FIG. 1 is a schematic top view of a machine protected by an enclosure to which a safety device according to the present disclosure is associated;

FIG. 2 is a schematic of the safety device according to an embodiment of the present disclosure; and

FIG. 3 is a schematic of the safety device according to another embodiment of the present disclosure.

### DETAILED DESCRIPTION

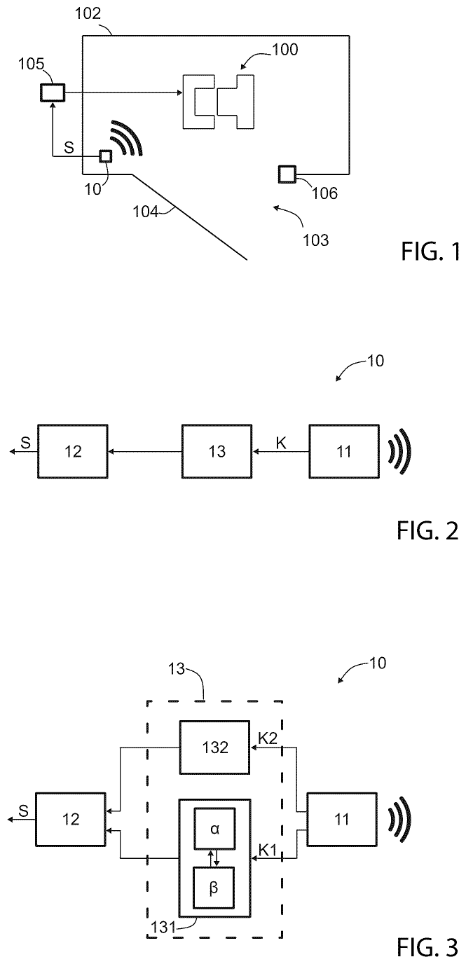

Referring to the example illustrated in FIG. 1, number 10 denotes a safety device according to the present disclosure configured to detect a hazardous condition for an operator of a machine 100 or industrial plant, hereinafter only machine 100, and activate a safety function of the same when the hazardous condition is present.

In this description and in the claims, a hazardous condition is understood to be a condition in which, if the 100 machine were started up or continued its operation, an operator could come into contact with a hazardous element of the 100 machine.

For example, but without limitation to generality, with reference to FIG. 1, in the case of a machine 100 surrounded by a protective barrier 102 provided with an access 103 protected by a movable guard 104, a hazardous condition exists when an operator can approach the machine 100 when it is in operation. For example, when the movable guard 104 allows an operator to pass the access 103 and approach the machine 100. In fact, in this case, if the machine 100 were to be started with the movable guard 104 allowing an operator to pass the access 103 and approach the machine 100, the operator could come into contact with a dangerous element of the machine 100 such as, for example, a moving, pressurized or hot organ or other.

Referring to FIG. 2, the safety device 10 comprises sensor means 11 configured to detect parameters K associated with the hazardous condition, a processing unit 13 (which may be or include a processor) configured to detect the hazardous condition based on the parameters K, and transmission means 12 controlled by the processing unit 13 and configured to safely transmit (e.g. as defined in European standards EN61508, EN62061, EN134849-1) a safety signal S to activate the safety function of the machine 100. For example, the safety signal S enables or inhibits the operation of the machine 100.

The choice of sensor means 11 depends on the type of safety device 10, i.e. the dangerous condition that is to be detected and the way in which it is detected.

By way of example, the sensor means 11 may comprise proximity sensors of a safety switch 106 associated with access 103 to detect whether an actuator (not shown) associated with the guard 104 is in proximity to the safety switch.

In this case, the half-sensors of the sensor means 11 detect the dangerous condition when the actuator is not in proximity of the safety switch 106, i.e. when the movable guard 104 is open. In this case, the parameters K comprise data relating to the signal transmitted from the actuator to the safety switch and detected by the proximity sensor.

Alternatively, or additionally, the safety switch 106 may include a locking mechanism for locking the actuator (not shown) in contact with the safety switch. The locking mechanism may have a locking position in which it locks the actuator in contact with the safety switch and an unlocking position in which it allows the actuator to move away from the safety switch 106. In this case, the sensor means 11 may comprise position sensors to detect the lock mechanism position and detect the dangerous condition when the lock mechanism is in the unlocked position, i.e. when the movable guard 104 is, or can be, opened. In this case, the parameters K comprise signals transmitted by the position sensors of the locking mechanism.

Alternatively, sensor means 11 comprise voltage sensors of the supply of an electric motor of the machine 100 or the current drawn by it. In this case, a hazardous condition exists if the motor current or voltage does not meet predetermined parameters. In this case, the K-parameters include voltage or current values measured over time.

Or, sensor means 11 comprise means of detecting the speed or position of a machine 100 load being moved by an electric motor configured to detect its speed. In this case, a hazardous condition exists if the load is in motion or if its speed does not comply with predetermined parameters. In this case, the K-parameters include the speed values measured over time.

In other embodiments, sensor means 11 may include optical sensors, radar, tof (time of flight), 2D, 3D cameras and others configured to monitor the machine 100 and an area surrounding it to detect the presence of foreign objects or an operator. In this case, a dangerous condition exists if an operator or foreign object is in the monitored area. In this case, K-parameters include two-dimensional images captured by optical sensors or three-dimensional images captured by 3D or tof cameras, or point clouds detected by radar sensors.

The person skilled in the art readily understands that the sensor means 11 can also be very different from those described here, depending on the dangerous condition to be detected, without departing from the scope of the present disclosure.

The transmission means 12 are configured to securely transmit the safety signal S to a control device 105 (FIG. 1) of a supervisory system of a large plant in which the machine 100 is inserted, or to the machine 100 itself.

By way of example, if the safety signal S indicates that the hazardous condition exists, the safety function of machine 100 is activated. Conversely, if the safety signal S indicates that the hazardous condition does not exist, the operation of the 100 machine is permitted.

Exemplarily, the transmission means 12 are configured to switch from an active state to an inactive state, or vice versa, when the sensor means 11 detect the hazardous condition. In these embodiments, the transmission means 12 comprise a pair of secure electronic outputs of the OSSD (Output Signal Switching Device) type driven by the processing unit 13.

By way of example only, an OSSD safe output in the active state transmits a signal and assumes a logical state of ‘1’ or ‘ON’ while in the inactive state it transmits no signal and assumes a logical state of ‘0’ or ‘OFF’.

Alternatively, or in addition, the transmission means 12 may be driven by the processing unit 13 to generate digital signals, i.e. sequences of bits, encoding a telegram according to a communication protocol. The communication protocol may be of a known types such as, for example, IO-Link, Profinet, EtherCAT, EtherNet/IP, IO-Link Safety, Profisafe, CIP Safety, Safety over EtherCAT (FSoE), etc. or any other protocol assimilated communication protocol. In this case, some bits of the telegram encode information about the dangerous condition detected by the processing unit 13.

Preferably, the telegram also includes validation bits (CRC, watchdog, numbers consecutive numbers with respect to previously transmitted) configured to guarantee the integrity of the telegram itself, generated as a function of the other bits in the telegram and/or according to previously transmitted telegrams.

The processing unit 13 is configured to process the parameters K detected by the sensors 11 in order to detect the dangerous condition. Furthermore, the processing unit 13 is configured to control the transmission means 12 in order to transmit the safety signal S if the dangerous situation is detected.

In accordance with an aspect of the present disclosure, the processing unit 13 includes a deterministic portion 131 configured to process at least a first portion K1 of the K parameters in accordance with a deterministic model. Further, the processing unit 13 further comprises a probabilistic portion 132 configured to process at least a second portion K2 of the K parameters in accordance with a probabilistic model.

Preferably, the deterministic portion 131 is distinct and separate from the probabilistic portion 132.

The first part K1 of the parameters K may be equal to the second part K2, or it may be only partially equal to the second part K2, or it may be completely different from the second part K2.

In accordance with a preferred embodiment, the processing unit 13 is configured to command the transmission means 12 to activate the safety function of the machine 100 if at least one of the deterministic portion 131 and the probabilistic portion 132 detects a dangerous situation.

In realization forms, the probabilistic portion 132 is configured to run a model that includes a neural network, or a support vector machine, or a logistic regression, or a decision tree, or a Bayesian classifier model, or a first k-kin classifier model, or Random Forest models, or Gradient Boosting models, or Hidden Markov models (HMM), or Gaussian Mixture models (GMM), or Expectation-Maximization (EM) models, or Recurrent Neural Networks (RNN) models.

Instead, the deterministic portion 131 comprises a classifier based on the comparison of the first K1 part of the K parameters with predetermined thresholds.

Even more preferably, in accordance with the forms of realization of FIG. 3, the deterministic portion 131 has a dual-channel fail-safe architecture and comprises a first α calculation unit and a second β calculation unit linked together in a redundant manner.

Preferably, the processing unit 13 is configured to activate the probabilistic portion 132 only when the deterministic portion 131 does not detect the hazardous condition. In this way, the probabilistic portion 132 only intervenes if the deterministic portion 131 would have already consented to the start-up of the machine 100. Advantageously, this simplifies the certification procedures of the safety device 10 according to national and international standards on functional safety of machinery since the probabilistic portion 132 would only intervene to further verify the safe condition of the machine also in accordance with a probabilistic model, only after the deterministic portion 131 has already given its consent to the start of the machine 100.

In this way, safety device 10 increases the safety level of machines or industrial plants while maintaining the reliability level of traditional safety devices.

The present disclosure also relates to a safety process executable by the device 10 according to the present disclosure to detect a dangerous situation in a machine 100 and to activate a safety function if the dangerous situation is detected.

The safety procedure involves detecting the K-parameters of machine 100 associated with the hazardous situation by means of sensors.

In addition, the safety procedure involves processing the K-parameters by processing unit 13 in order to detect the dangerous situation.

The procedure also involves safely transmitting a safety signal S to activate a safety function of machine 100 if the dangerous condition is detected.

In accordance with one aspect of the present disclosure, at least a first part K1 of the K-parameters is worked out in accordance with a deterministic model and at least a second part K2 of the K-parameters is worked out in accordance with a probabilistic model.

The safety signal S is transmitted if at least one of the deterministic model processing and the probabilistic model processing detects the dangerous situation.

In preferred forms of realization, the second K2 part of the K-parameters is only processed in accordance with the probabilistic model if a previous processing of the first K1 part of the K-parameters in accordance with the deterministic model does not detect the hazardous situation.

What is claimed is:

1. A safety device configured to detect a hazardous situation in an industrial machine or plant and to activate a safety function of the industrial machine or plant in response to detecting the hazardous situation, wherein the safety device comprises:
sensor means configured to detect parameters of the industrial machine or plant associated with the hazardous situation;
transmission means configured to safely transmit a safety signal to activate the safety function of the industrial machine or plant; and
a processing unit configured to process the parameters in order to detect the hazardous situation and to control the transmission means in order to transmit the safety signal;
wherein the processing unit comprises a deterministic portion configured to process at least a first part of the parameters in accordance with a deterministic model and a probabilistic portion configured to process at least a second part of the parameters in accordance with a probabilistic model.

2. The safety device as in claim 1, wherein the processing unit is configured to control the transmission means to transmit the safety signal in order to activate the safety function of the industrial machine or plant if at least one of the deterministic portion or the probabilistic portion detects the hazardous situation.

3. The safety device as in claim 1, wherein the probabilistic portion comprises a neural network, or a support vector machine, or a logistic regression, or a decision tree, or a Bayesian classifier model or an early k-vini classifier model, or Random Forest models, or Gradient Boosting models, or Hidden Markov models (HMM), or Gaussian Mixture models (GMM), or Expectation-Maximization (EM) models, or Recurrent Neural Networks (RNN) models.

4. The safety device as in claim 1, wherein the deterministic portion is configured to compare the at least a first part of the parameters with predetermined thresholds.

5. The safety device as in claim 1, wherein the sensor means comprises optical sensors configured to capture images of the industrial machine or plant.

6. The safety device as in claim 1, wherein the sensor means is configured to detect physical quantities associated with operation of an electric motor and/or a load moved by the electric motor and the parameters are calculated on the basis of the physical quantities.

7. A safety procedure for detecting a hazardous situation in an industrial machine or plant and for activating a safety function of that machine if that hazardous situation is detected, the safety procedure comprising the following steps:
detecting parameters of the industrial machine or plant associated with the hazardous situation; and
processing the parameters in order to detect the hazardous situation;
wherein at least a first part of the parameters is processed according to a deterministic model and at least a second part of the parameters is processed according to a probabilistic model.

8. The safety procedure as in claim 7, further comprising a step of safely transmitting a safety signal to activate a safety function of the industrial machine or plant in response to detecting the hazardous situation.

9. The safety procedure as in claim 8, wherein the safety signal is transmitted in response to at least one of the deterministic model or the probabilistic model detecting the hazardous situation.

10. The safety procedure as in claim 9, wherein the second part of the parameters is processed in accordance with the probabilistic model if a previous processing of the first part of the parameters in accordance with the deterministic model does not detect the hazardous situation.

11. A safety device configured to detect a hazardous situation in an industrial machine or plant and to activate a safety function of the industrial machine or plant in response to detecting the hazardous situation, wherein the safety device comprises:
at least one sensor configured to detect parameters of the industrial machine or plant associated with the hazardous situation;
a transmitter configured to safely transmit a safety signal to activate the safety function of the industrial machine or plant; and
a processor configured to process the parameters in order to detect the hazardous situation and to control the transmission means in order to transmit the safety signal;
wherein the processor comprises a deterministic portion configured to process at least a first part of the parameters in accordance with a deterministic model and a probabilistic portion configured to process at least a second part of the parameters in accordance with a probabilistic model.

12. The safety device as in claim 11, wherein the processor is configured to control the transmitter to transmit the safety signal in order to activate the safety function of the industrial machine or plant if at least one of the deterministic portion or the probabilistic portion detects the hazardous situation.

13. The safety device as in claim 11, wherein the probabilistic portion comprises a neural network, or a support vector machine, or a logistic regression, or a decision tree, or a Bayesian classifier model or an early k-vini classifier model, or Random Forest models, or Gradient Boosting models, or Hidden Markov models (HMM), or Gaussian Mixture models (GMM), or Expectation-Maximization (EM) models, or Recurrent Neural Networks (RNN) models.

14. The safety device as in claim 11, wherein the deterministic portion is configured to compare the at least a first part of the parameters with predetermined thresholds.

15. The safety device as in claim 11, wherein the at least one sensor comprises optical sensors configured to capture images of the industrial machine or plant.

16. The safety device as in claim 11, wherein the at least one sensor is configured to detect physical quantities associated with operation of an electric motor and/or a load moved by the electric motor and the parameters are calculated on the basis of the physical quantities.
